(19) United States
(12) Patent Application Publication
(10) Pub. No.: US 2014/0003769 A1
(43) Pub. Date: Jan. 2, 2014

(54) QUICK CONNECT COUPLER FOR OPTICAL FIBER CABLE

(71) Applicant: Precision Optics Corporation, Inc., Gardner, MA (US)

(72) Inventors: David Chambers, Warren, MA (US); Joseph Forkey, Princeton, MA (US); Robert Ross, Gardner, MA (US)

(73) Assignee: Precision Optics Corporation, Inc., Gardner, MA (US)

(21) Appl. No.: 13/932,387

(22) Filed: Jul. 1, 2013

Related U.S. Application Data
(60) Provisional application No. 61/666,161, filed on Jun. 29, 2012.

(51) Int. Cl. G02B 6/38

(52) U.S. Cl. CPC G02B 6/3807
USPC 385/69

(57) ABSTRACT

A quick connect coupler for interconnecting small-diameter optical fiber bundles between an instrument and an illumination source. The quick connect coupler includes a connector body with a fitting that carries optical fiber from an illumination source. A stem attaches to optical fiber from the instrument. The stem is inserted into the connector body until shoulders on each abut and prevent further relative motion. Arms on the connector body ride over a band on the stem and capture the stem within the connector body. As a result, the gap between the adjacent ends of the optical fiber from the illumination source and the instrument can be fixed at a well-controlled small size, thereby minimizing any light loss through the quick connect coupler.

### CROSS REFERENCE TO RELATED APPLICATION

The application in a non-provisional application claiming priority from co-pending U.S. Provisional Patent Application Ser. No. 61/666,161 filed Jun. 29, 2012 for a Quick Connect Coupler for Optical Fiber Cable.

### BACKGROUND OF THE INVENTION

1. Field of the Invention

This invention generally relates to couplers for optical fiber and more specifically to quick connect couplers for conveying light from a source optical fiber cable to an adjacent end of destination optical fiber cable with minimum light loss.

2. Description of Related Art

Prior quick connect couplers for optical fiber cables have application in many fields including the medical field. Such couplers accommodate cables with optical fiber bundles having diameters of 4 to 5 mm. These couplers are used in applications where the amount of optical fiber is large enough to overcome losses caused by relatively large spacing or gaps between, and axial alignment of, adjacent ends of source and destination optical fibers.

There now is an effort underway to miniaturize optical fiber systems for use in areas of restricted access. For example, it now is desirable to provide an optical fiber system in which portions of destination optical fiber remote from a quick connect coupler can be brought into close proximity of a surgical site to illuminate that site or a portion thereof. As will be apparent, it is important that at least the portion of the optical fiber system that may contact tissue at the surgical site be either autoclavable or disposable. Such applications require a quick connect coupler between the portion of the instrument that is brought into proximity to the surgical site and the illumination source. The existence of such a quick connector coupler provides two advantages. First, a single illumination source can provide light to different instruments. Second, an instrument and destination optical fiber cable can be disconnected from the source optical fiber cable for purposes of sterilization of or disposal of the destination optical fiber and any affixed instrumentation.

This demand for increased miniaturization requires an even further reduction in the cross section of an optical fiber or bundle of optical fibers while continuing to illuminate a surgical or other site at acceptable levels. For example, there are now a number of applications in which the optical fiber or bundle has a cross sectional diameter of approximately 2.5 mm. In some applications it may be possible to increase the power of the illumination source. However, in many situations the actual power may be limited by industry standards or in others it may not be desirable to obtain an illumination source with a higher power rating. Therefore, merely increasing the power of the illumination source is not always a viable alternative.

In situations where an existing illumination source will continue to be used, reducing the optical fiber cross section can give rise to two requirements for a quick connect coupler. First, the coupler must control the axial spacing or gap between the adjacent ends of the optical fiber in the source and destination optical fiber cables, so that they are very close, but not touching. Any variation in the axial spacing or gap must be minimized as different destination optical fiber cables are exchanged in the quick connect coupler. Second, the coupler must align the optical fibers axially. That is, to be effective with smaller optical fibers or optical fiber bundles a quick connect coupler must maintain a spatial relationship between the source and destination optical fiber cables.

What is needed is a quick connect coupler that establishes a spatial relationship between the adjacent ends of optical fiber in source and destination optical fiber cables by minimizing the air gap therebetween and by aligning the optical fibers within the quick connect coupler and that is commercially manufacturable and easy to use.

### SUMMARY

It is an object of this invention to provide a quick connect optical fiber coupler that minimizes light loss.

Another object of this invention is to provide a quick connect optical fiber coupler that establishes a spatial relationship between adjacent ends of source and destination optical fibers that minimizes light loss in the quick connect coupler.

Still another object of this invention is to provide a quick connect optical fiber coupler that is commercially manufacturable and that is easy to use.

### BRIEF DESCRIPTION OF THE DRAWINGS

The appended claim particularly points out and distinctly claims the subject matter of this invention. The various objects, advantages and novel features of this invention will be more fully apparent from a reading of the following detailed description in conjunction with the accompanying drawings in which like reference numerals refer to like parts, and in which:

FIG. 1 is a block diagram of an instrumentation system with a quick connect coupler that incorporates this invention;

FIG. 2 is a cross-section of a stem component that is included in the quick connect coupler of FIG. 1;

FIG. 3 is a cross-section of a fitting component that is included in the quick connect coupler of FIGS. 1;

FIG. 4 is a cross-section of a connector body component that is included in the quick connect coupler of FIG. 1;

FIG. 5 is a cross-section of an assembled quick connect coupler that incorporates this invention;

FIG. 6 is a perspective view of a portion of the instrumentation system of FIG. 1 with the quick connect coupler in a separated state;

FIG. 7 is a perspective view of the quick connect coupler of FIG. 1 when the quick connect coupler is assembled in an operative state;

FIG. 8 is a cross-section of an alternative connector body for use with the stem component of FIG. 2 and the fitting component of FIGS. 3; and

FIG. 9 is a cross-section of the connector body of FIG. 8 assembled with the fitting component of FIG. 3.

### DESCRIPTION OF ILLUSTRATIVE EMBODIMENTS

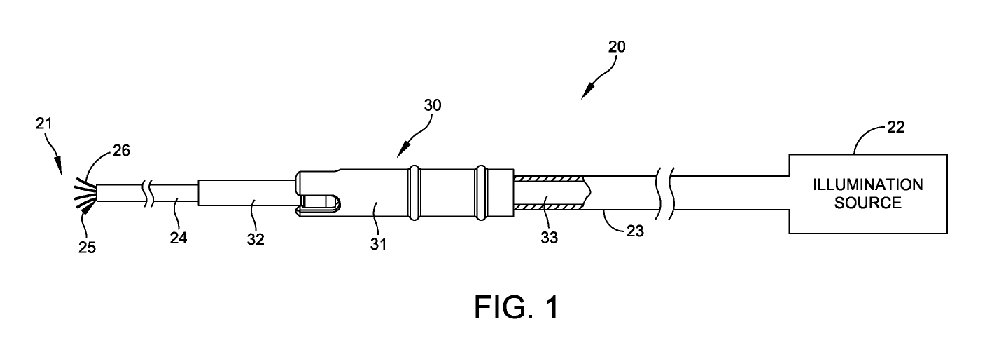

FIG. 1 discloses, in block form, an instrumentation system 20 for providing illumination at a surgical or other remote access area 21. The system 20 includes an illumination source 22 with a source optical fiber cable 23 and a destination optical fiber cable 24 that extends to a distal end 25 from which light 26 emanates when the illumination source 22 is energized. Each optical fiber cable in FIG. 1 comprises at least one optical fiber encased by a sheath.

In accordance with this invention, a quick connect coupler 30 provides the appropriate spatial relationship between the adjacent ends of optical fiber in the source optical fiber cable 23 and the destination optical fiber cable 24. This embodiment of a quick connect coupler 30 contains three basic components, namely: a connector body 31, a stem 32 attached to the proximal end of the destination optical fiber cable 24 for being inserted into the distal end of the connector body 31, and a fitting 33 attached to the distal end of the source optical fiber cable 23 for being inserted into the proximal end of the connector body 31.

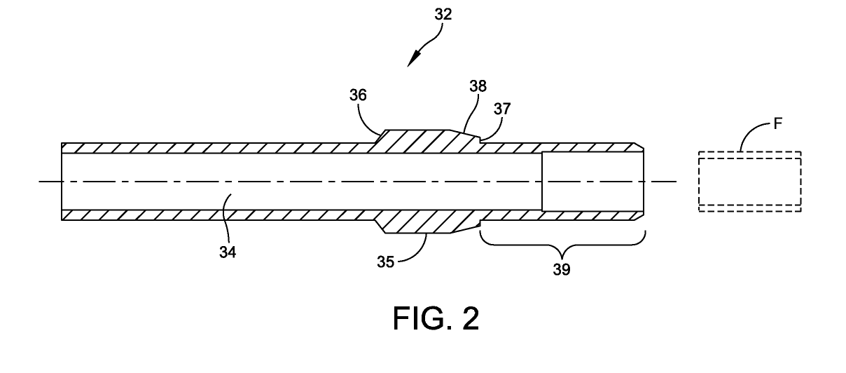

FIG. 2 depicts one embodiment of the stem 32 that defines a central axial passage 34 and an intermediate external circumferential band 35. The band 35 includes a steep ramp 36 at its distal end and a radial shoulder 37 at its proximal end. A ramp 38 with an intermediate slope extends between the shoulder 37 and the outer surface of the main portion of the band 35. A portion 39 of the stem 32 extends proximally from the shoulder 37. Optical fiber fills the passage 34. The distance between the proximal end of the portion 39 and the shoulder 37 is a factor in setting the final spatial relationship between the adjacent ends of the optical fiber in optical fiber cables 23 and 24 shown in FIG. 1. Still referring to FIG. 2, an optional bushing or ferrule F, shown in phantom, may be inserted into the proximal end of the stem 32, particularly into the end of the portion 39 (i.e., from the right side in FIG. 2) to grip and support the ends of the optical fiber or fibers in the stem 32.

During assembly, optical fiber is transferred from the distal end of the stem 32 through the passage 34 to its proximal end (the right end in FIG. 2). The ferrule F, if used, is applied from the proximal end. The optical fiber is then moved distally (to the left) until the ferrule F seats in the proximal end of the stem 32. Adhesive or other affixing materials or methods then lock the optical fiber in the passage 34. The proximal end of the optical fiber is ground and polished to a known, controlling distance from the shoulder 37.

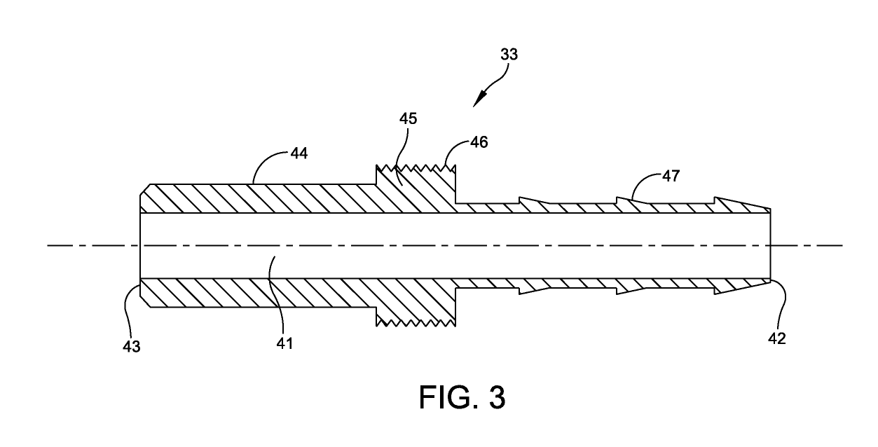

FIG. 3 depicts one embodiment of the fitting 33 that defines a central passage 41 extending between proximal and distal ends 42 and 43, respectively, for carrying the optical fibers of the source optical fiber cable 23. A body portion 44 of a first diameter extends proximally from the distal end 43 to an intermediate position defined by band 45 of increased diameter with external threads 46. A barbed extension 47 extends proximally from the band 45 and, during assembly, lies between the optical fiber and sheath of the source optical fiber cable 23 of FIG. 1. After assembly during which the fitting 33 is slid over the distal end of the source optical cable 23, the fitting 33 and optical cable 23 are bonded together as by the application of an adhesive or other equivalent means. The distal end 43 then is ground and polished.

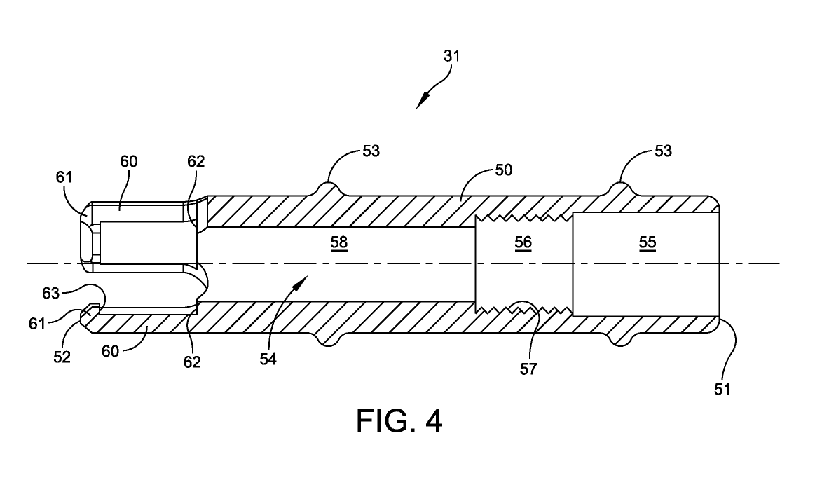

FIG. 4 depicts an embodiment of a connector body 31 that has a substantially cylindrical body portion 50 extending between a proximal end 51 and a distal end 52. The outer surface of the body portion 50, in this embodiment, includes spaced circumferentially extending ribs 53 to enhance the gripping properties of the connector body 31. A central passage 54 includes axially spaced cavities of different diameters. A proximal-most cavity 55 has a diameter that enables the threaded band 45 in FIG. 3 to reach an adjacent cavity 56 in FIG. 4. The adjacent cavity 56 has internal threads 57 that engage the external threads 46 on the fitting 33 of FIG. 3 to advance the fitting 33 initially distally within the connector 31 and subsequently either distally or proximally to adjust the final position of the polished end surface at the distal end 43 of the fitting 33 in FIG. 3 in the connector body 31 of FIG. 4. A cavity 58 has a diameter that allows a sliding fit with the stem portion 39 shown in FIG. 2.

Still referring to FIG. 4, the connector body 31 terminates at its distal end 52 with a plurality of angularly spaced and axially and distally extending arms 60 that are adapted to flex radially thereby to allow displacement of the ends 61 thereof. FIG. 4 depicts a connector body 31 with three such arms. Each arm 60 extends from a radial shoulder 62. The radial shoulder 62 forms a stop for engaging the shoulder 37 of the stem 32 as shown in FIG. 2. The shoulder 62 may be formed as a continuous shoulder or as or a segmented shoulder with portions at each location of an arm 60. Other arm configurations and other structures could be substituted so long as they provide the locking and positioning functions to be described.

Each arm 60 has a length such that when the shoulders 37 and 62 engage, inner shoulders 63 on each arm engage the steep ramp 36 of FIG. 2, preferably at an intermediate position along the steep ramp 36. Reasonably attainable manufacturing tolerances allow tight control of the distance between the shoulder 37 and the proximal end of the stem portion 39 and the distance between the shoulder 62 and the distal end 43 of the fitting 33 within the connector body 31.

During manufacture the fitting 33 of FIG. 3 with the attached source optical fiber cable 23 is inserted into the connector body 31 of FIG. 4. When the threads 46 and 57 engage, relative rotation between the connector body 31 and the fitting 33 advances the fitting 33 into the connector body 31. When the distal end 43 of the fitting 33 reaches a distance from the shoulder 62 that is equal to the length of the stem portion 39 plus a small well-defined distance (e.g., 0,1 mm) the fitting 33 is accurately positioned to establish the required spatial relationships and may be locked in place by adhesive or any equivalent means.

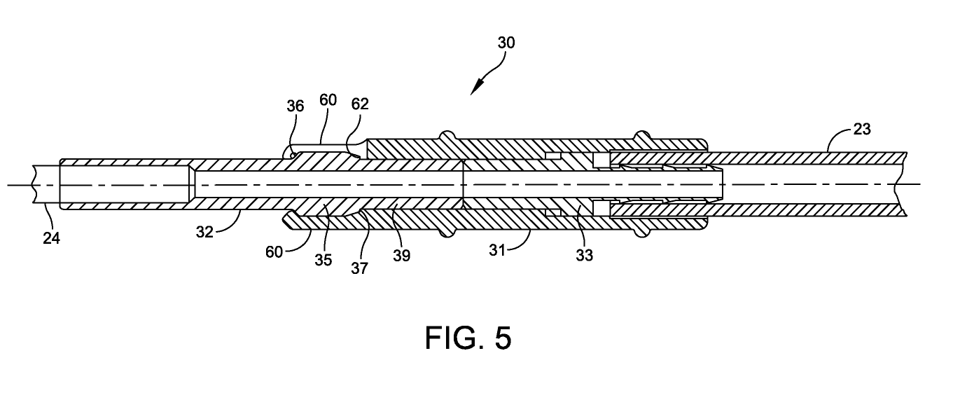

FIG. 5 depicts the quick connect coupler 30 in an operative state with an attached source optical fiber cable 23 and a destination optical fiber cable 24. The stem 32 with its attached optical fiber cable 24 has, as previously described, been inserted from the distal end into the connector body 31 to a reference position. As an individual inserts a stem 32 with its attached destination optical fiber cable 24, the stem portion 39 passes the arms 60 causing only minimal deflection. As the ramp 38 passes, the arm ends 61 deflect radially outward and then clamp onto the steep ramp 36 as the shoulders 37 and 62 abut and stop further relative axial motion of the stem 32 in the connector body 31. This, as will now be apparent, locks the stem 32 into position within the connector body 31. The proximal end of the destination optical fiber cable 24 and the distal end of the source optical fiber cable 23 are separated by only a minimal gap that does not create significant transmission losses.

The combination of the connector body 31, stem 32 and fitting 33 assure that the source and destination optical fiber cables 23 and 24 are aligned axially and centered within the connector body 31. The gap between the adjacent ends of the optical fiber in the stem 32 and the fitting 33 remains within an acceptable tolerance and has a constant width. That is, this structure assures that the desired spatial relationship of the optical fiber cables 23 and 24 necessary for minimal light loss across the coupler 30 are achieved and maintained.

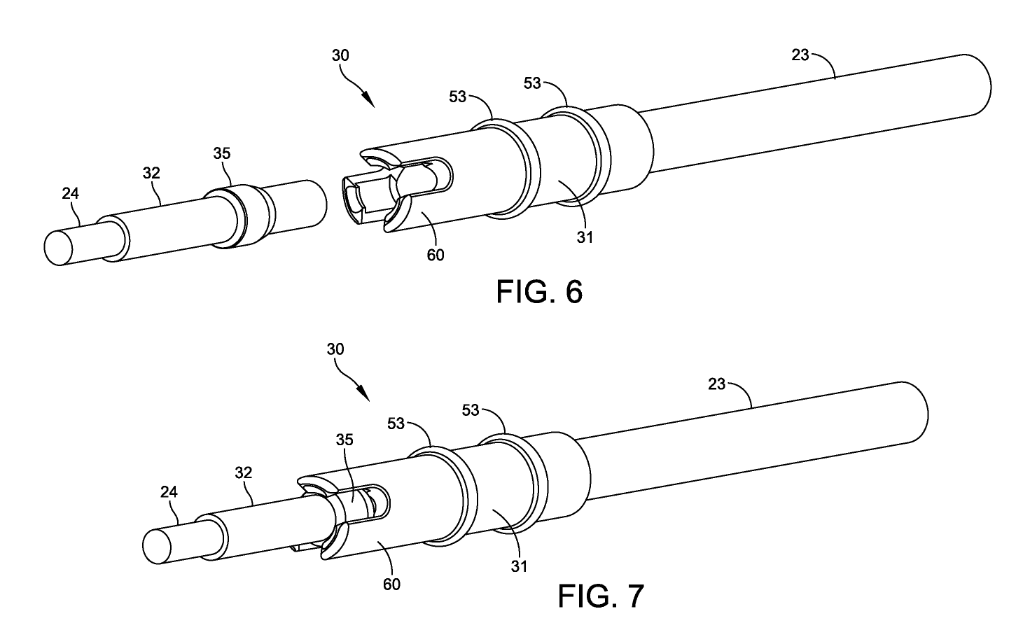

In use, an individual selects a specific instrument including a fiber optical cable 24 with an integral stem 32 as shown in FIG. 6. The individual grasps the connector body 31 and the stem 32 and inserts the stem 32 into the connector body 31 through the arms 60 as shown in FIG. 7. As the band 35 reaches the distal end of the connector 31, the individual continues to insert the stem 32 until the shoulder 37 hits the shoulder 62 (in FIG. 5) and the arms 60 collapse and lock the stem in place. After the instrument use has been completed, the individual merely grasps the exposed portion of the stem 32 and the connector body 31 and pulls them apart whereupon the stem 32, the optical fiber cable 24 and any attached instrumentation can be autoclaved for reuse or thrown away if disposable.

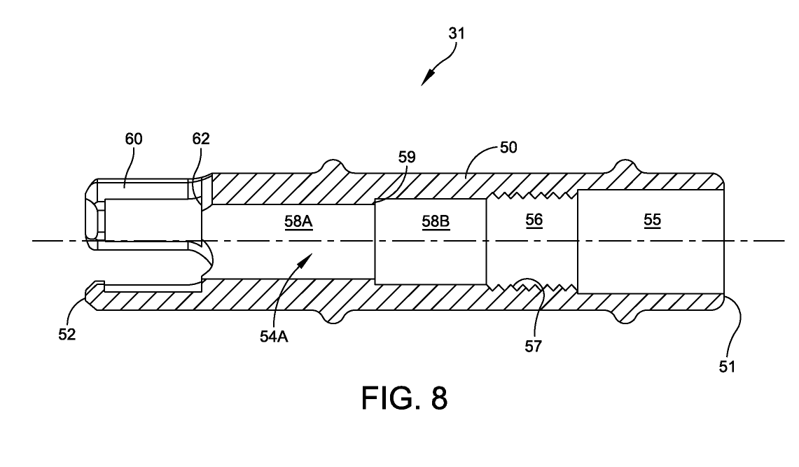

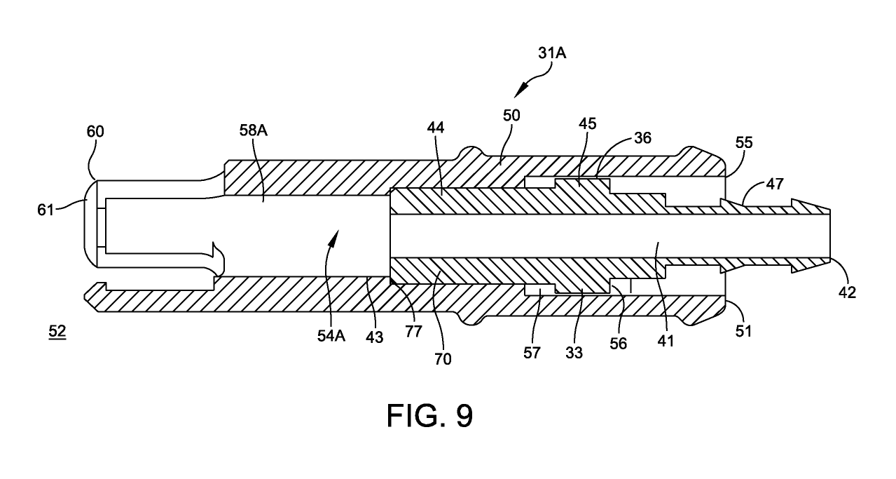

FIGS. 8 and 9 depict a connector body 31A, which is an alternate embodiment of the connector body 31 in FIG. 4. As many of the features in the two embodiments are the same, like reference numerals refer to like features. Variations add the suffix “A” to the reference numeral. The connector body 31A includes a cylindrical body portion 50A Like the body portion 50 in FIG. 4, the body portion 50A 31A extends between a proximal end 51 and a distal end 52. It has a modified central passage 54A with the same cavities 55 and 56 as shown in FIGS. 4 and 8. A difference is that the cavity 58 in FIG. 4 is divided into adjacent cavities 58A and 58B in FIG. 8 with different diameters. The cavity 58A has the same diameter as the cavity 58 in FIG. 4 to allow a sliding fit with the stem portion 39 shown in FIG. 2. The cavity 58B has a diameter that is larger than the diameter of the cavity 58A and less than the cavity 56 thereby to form a shoulder 59 as an axial stop at the common boundary of the cavities 58A and 58B. This boundary is positioned axially to be displaced proximally from the shoulder 62 by a distance corresponding to the length of the portion 39 of the stem 32 shown in FIG. 2.

Referring to FIG. 9, during manufacture a fitting 33 is inserted into the connector body 31A until it reaches a first stop when the proximal most internal threads 57 of the connector body 31 engage the distal most threads of the external threads 46 on the fitting 33. Then relative rotation of the connector body 31A and the fitting 33 causes the threads to engage and the fitting 33 advances distally in the connector body 31 until that distal end 43 of the fitting 33 abuts the shoulder 59. As an optional step, an adhesive can be applied to the threads 46 and/or 57 to lock the fitting 33 to the connector body 31. This positions the distal end 43 so that the distal end 43 of the fitting 33 will be in a proper relationship with the proximal end of the stem 32. When assembled, the combination of the connector body 31A, the stem 32 and the fitting 33 assure that the source and destination optical fiber cables are aligned axially and separated by only a minimum gap.

A quick connect coupler constructed in accordance with this invention meets all the objectives for devices that utilize small-diameter optical fiber for illumination of areas having restricted access. Such a quick connect coupler introduces minimal light loss. Specifically a quick connect coupler incorporating this invention provides a spatial relationship between adjacent ends of source and destination optical fibers that the gap therebetween is very small and well controlled. It will also be apparent that a quick connect coupler constructed in accordance with this invention is easy to use and does not require the manipulation of various clips or other fastening structures.

This invention has been disclosed in terms of certain embodiments. It will be apparent that many modifications can be made to the disclosed apparatus without departing from the invention. For example, there are applications in which the stem of FIG. 2 is permanently attached to an instrument and the destination optical fiber cable includes only an optical fiber bundle connected from the instrument to through the stem. Therefore, it is the intent of the appended claims to cover all such variations and modifications as come within the true spirit and scope of this invention.

What is claimed as new and desired to be secured by Letters Patent of the United States is:

1. A quick connect coupler that transfers light from a source optical fiber cable to a destination optical fiber cable, said quick connect coupler comprising a stem attached to the destination optical fiber cable, a fitting attached to the end of a source optical fiber cable, and a connector body, wherein:
A) said stem comprises a passage for receiving optical fiber from the destination optical fiber cable at the distal end thereof whereby the optical fiber terminates at proximal end thereof and a circumferentially extending band at a predetermined axially intermediate position and with ramps on either end thereof,
B) said fitting comprises a passage for receiving optical fiber from the source optical fiber cable at the proximal end thereof whereby the optical fiber terminates at the distal end thereof, and a circumferentially extending band at an intermediate position along the fitting, and
C) said connector body comprises an axially extending passage for receiving the fitting, means in the proximal portion of the passage for interacting with said fitting thereby to establish a known position of the fitting relative to the distal end of said connector body, means in the distal portion of said passage for receiving said stem with the attached destination optical fiber cable, and at least one radially deflectable arm axially and distally extending from said distal end of said connector, each of said at least one radially deflectable arm for engaging said stem band thereby to lock said stem in said connector at a known axial position relative to the end of the source optical fiber cable.

2. A quick connect coupler adapter as recited in claim 1 wherein the slope of said stem ramp at the distal end of said stem is greater than the slope of the other of said ramps.

3. A quick connect coupler as recited in claim 2 wherein said fitting and said stem include complementary threads thereby to locate the distal end of said fitting at the known position.

4. A quick connect coupler as recited in claim 3 additionally comprising means for locking said fitting at the known position.

5. A quick connect coupler as recited in claim 3 wherein said connector body includes an axial stop to limit the axial motion of said fitting toward the distal end of said connector body.

6. A quick connect coupler that transfers light from a source optical fiber cable to a destination optical fiber cable, said quick connect coupler comprising a stem attached to one of the source optical fiber cable and destination optical fiber cable, a fitting attached to the end of the other of the source optical fiber cable and destination optical fiber cable, and a connector body, wherein:
A) said stem comprises a passage for receiving the attached optical fiber cable at the distal end thereof whereby the optical fiber terminates at proximal end thereof and a circumferentially extending band at a predetermined axially intermediate position and with ramps on either end thereof,
B) said fitting comprises a passage for receiving the attached optical fiber cable at the proximal end thereof whereby the attached optical fiber terminates at the distal end thereof, and a circumferentially extending band at an intermediate position along the fitting, and
C) said connector body comprises an axially extending passage for receiving the fitting, means in the proximal portion of the passage for interacting with said fitting thereby to establish a known position of the fitting relative to the distal end of said connector body, means in the distal portion of said passage for receiving said stem with the attached destination optical fiber cable, and at least one radially deflectable arm axially and distally extending from said distal end of said connector, each of said at least one radially deflectable arm for engaging said stem band thereby to lock said stem in said connector at a known axial position relative to the end of the optical fiber cable in said fitting.

7. A quick connect coupler adapter as recited in claim 6 wherein the slope of said stem ramp at the distal end of said stem is greater than the slope of the other of said ramps.

8. A quick connect coupler as recited in claim 7 wherein said fitting and said stem include complementary threads thereby to locate the distal end of said fitting at the known position.

9. A quick connect coupler as recited in claim 8 additionally comprising means for locking said fitting at the known position.

10. A quick connect coupler as recited in claim 8 wherein said connector body includes an axial stop to limit the axial motion of said fitting toward the distal end of said connector body.
